(19) United States
(12) Patent Application Publication
(10) Pub. No.: US 2016/0068685 A1
(43) Pub. Date: Mar. 10, 2016

(54) PROCESS FOR PRODUCING AN ANTI-ADHERENT SEMI-PASTE COMPOUND FOR LIQUID STEEL ON SOLID METAL AND AN ANTI-ADHERENT SEMI-PASTE COMPOUND FOR LIQUID STEEL ON SOLID METAL

(71) Applicant: Maycon Isense DALPIAZ, (US)

(72) Inventor: Maycon Isense DALPIAZ, Sao Paulo (BR)

(21) Appl. No.: 14/765,289

(22) PCT Filed: Jan. 17, 2014
(86) PCT No.: PCT/BR2014/000008

§ 371 Date: Oct. 23, 2015

(30) Foreign Application Priority Data
Jan. 31, 2013 (BR) 10 2013 002396 5

(51) Int. Cl. C09D 5/00; C09D 7/14

(52) U.S. Cl. CPC C09D 5/00; C09D 7/14

(57) ABSTRACT

A process for producing an anti-adherent semi-paste compound for liquid steel on solid metal, as well as an anti-adherent semi-paste compound for liquid steel on solid metal, are disclosed. The semi-paste compound may include a mixture of sodium tripolyphosphate, citric acid, sodium hydroxide, sodium ricinoleate, sodium silicate, benzalkonium chloride, gum, silicone oil, water, isothiazolinone and sulphonic acid. The compound may not include any volatile substances. The compound may be neutralized to a pH of 7.2±0.5.

### CROSS-REFERENCE TO RELATED APPLICATIONS

The present application is a national phase application of PCT application number PCT/BR2014/000008, with an international filing date of Jan. 17, 2014, which claims the priority benefit of Brazilian application number 10 2013 002396 5, filed Jan. 31, 2013, the disclosures of which are incorporated herein by reference in their entirety for all purposes.

### BRIEF DESCRIPTION

This application for Patent of Invention refers to a Process For Producing An Anti-Adherent Semi-Paste Compound For Liquid Steel On Solid Metal And An Anti-Adherent Semi-Paste Compound For Liquid Steel On Solid Metal, specifically to a process for producing a semi-paste compound and its product, resulting in an anti-adherent composition that can be easily applied, is resistant to high temperatures, and is recommended for the protection of any equipment liable to come into direct contact with and/or be sprayed by liquefied metals such as, for instance, welding metal residues in general.

### BACKGROUND OF THE INVENTION

1. Field of the Invention

In a first aspect, the invention is particularly suitable for equipment needing protection against the projection of liquid metals by applying the compound directly on the surfaces where it is intended to prevent the adherence of liquid metal and weld splash.

In a second aspect, the invention is particularly suitable to protect floors, walls, pots, refractory materials in general, although not limited to these, by preventing the adherence of liquid metal and weld residues as well as the darkening of those surfaces, thus contributing to the durability thereof.

2. Description of the Related Art

The currently existing technologies to protect equipment operating effectively in metal welding are: pneumatic countersink, blowtorch cut, sugarcane molasses and refractory mass; however, such current protection techniques incur in several drawbacks that should be pointed out:

Pneumatic countersink: It is not efficient because it depends on the amount of crust adhering to the equipment and if the pressure of the countersink nuts is increased, the lifting and lowering system of the shaft shuts down.

Blowtorch cut: It can damage the equipment because if cutting is not precise it produces galling on the shaft which acts as an anchor point for new crust, in addition to causing a great number of labor accidents;

Sugarcane molasses: It vitrifies and thus it increases the equipment diameter and does not provide the desired efficiency. The application is manual, exposing the employee to hazards of high temperature radiation;

Refractory mass: Difficulties in applying which require that the employee(s) is/are exposed to high temperatures, for a measured time of 3 minutes 18 seconds (3′18″), long removal time of 1 minute and 30 seconds (1′30″), average time of exposure to high temperatures of 4 minutes and 48 seconds (4′48″), in addition to product losses during application, damage to the equipment on removal of the mass which is petrified or presents “crust adherence” during the spraying of liquid steel; due to the application difficulties the ergonomic problem are considerable; removal of scale formations in various types of metallurgy equipment. There may be used pneumatic and/or impact removers that damage the equipment and even compromise the inner coating made of refractory material, occasionally causing serious accidents such as liquid steel leaking when using blowtorches to cut the crust “adhered” to the equipment.

Having in mind these drawbacks, the manufacturers that pay more attention to the market demand aim to develop products that provide greater practicality, simplicity and efficiency, in conformity with the focus of the instant patent application, in order to increase their headway in the consumer market.

### PRIOR ART

The current prior art includes some patent documents that refer to the subject matter under consideration, such as PI 0902688-6, with the title “Composition Of Refractory Mass”. This document describes a new composition of ingredients for the obtainment of a mass for application as a refractory coating ion metallurgical furnaces and similar equipment comprising from 30% to 60% by weight of silicon (SiO2) of medium and large grain size, from 40% to 60% by weight of micronized aluminum oxide (Al2O3) and from 28% to 35% by weight of a sodium silicate-based adhesive.

There has also been found document PI 0302688-4, with the title “Silica-Based Refractory Mass Composition”, in which a silica-based refractory mass is produced by using clusters made of vitreous and/or crystalline silica associated with special additions, for the manufacture of refractory coatings for various applications. The improved compositions claimed and described in PI 0302688-4 comprise, in a first version: a) at least 90% by mass of silica aggregates, wherein at least 90% of these aggregates are made of electrically-melted vitreous silica and the rest of active silica active; b) from 2 to 10% by mass of tin oxide (SnO2); c) from 1 to 5% by mass of ethyl silicate; d) from 0.2 to 2% by mass of calcium aluminate cement belonging to the category of 60 to 80% of Al2O3; e) from 1 to 10% by mass of colloidal silica; f) from 1 to 100 ml of aqueous solution of monoethanolamine for each 50 to 100 ml of ethyl silicate; g) from 0.01 to 0.10% of the mass of solids of n-octanol; h) from 0.05 to 0.20% of the mass of solids of isopropanol or polypropylene glycol; and i) from 2 to 6% of the mass of solids of water, and in a second version, the compositions comprise: a) at least 70% by mass of crystalline silica aggregates with 12% of active silica and 10 to 25% of electrically-melted vitreous silica with grain size of less than 0.045 mm; b) from 0.1 to 1.0% by mass of ethyl silicate; c) from 1.0 to 10% by mass of colloidal silica; d) from 0.05 to 0.15% by mass of ammonium polyacrylate, or sodium and/or ammonium naphthalene sulfonic sodium salt condensed with formalin or condensed melamine, or sodium hexametaphosphate or sodium tripolyphosphate or sodium polyacrylate, or citric acid or sodium citrate used alone or mixed in pairs or in groups; e) from 0.01 to 0.10% of the mass of n-octanol solids; f) from 0.05 to 0.20% of the mass of solids of isopropanol or polypropylene glycol; and g) from 2.0 to 7.0% by mass of solids of water.

As it can be observed, although the above-mentioned patents present inventive concepts of refractory mass for protection against high temperature, they incur in the same drawbacks mentioned above.

### SUMMARY OF THE CLAIMED INVENTION

In view of these facts, the inventor developed the Process For Producing An Anti-Adherent Semi-Paste Compound For Liquid Steel On Solid Metal And An Anti-Adherent Semi-Paste Compound For Liquid Steel On Solid Metal under consideration, which, in general terms, is a process for producing a semi-paste compound and its product, resulting in an anti-adherent composition that can be easily applied, is resistant to high temperatures, and recommended for the protection of any equipment liable to come into direct contact with and/or be sprayed by liquefied metals such as, for instance, liquid metal and welding metal residues in general.

The Process For Producing An Anti-Adherent Semi-Paste Compound For Liquid Steel On Solid Metal And An Anti-Adherent Semi-Paste Compound For Liquid Steel On Solid Metal refers to the production of a compound with no addition of ammonia, plant solvents and/or hydrocarbons, which in this case is different since it does not contain any volatile component in its formulation and can be used in places wherein are encountered high temperatures or sources of ignition without entailing the risk of fire and/or explosion.

In the Process For Producing An Anti-Adherent Semi-Paste Compound For Liquid Steel On Solid Metal And An Anti-Adherent Semi-Paste Compound For Liquid Steel On Solid Metal, the formula thereof is neutralized with a pH of 7.2±0.5 without causing any problem regarding the harm to the skin of the individual applying the product or anyone involved in the application thereof.

### Advantages of the Invention

In summary, the main advantages of the patent claimed herein are the following:

It substantially reduces the applicator's exposure time during the application process to only thirty seconds;

The compound does not need to be removed following each application since it does not “stick” to the crust;

The compound is a biodegradable product;

The compound withstands temperatures higher than two thousand degrees Celsius;

The operations of inspection of the protected equipment are quicker;

Since no impact is involved in the removal of the mass and/or “crust” the useful life of the protected equipment is significantly increased;

Better ergonomics since the employee does not need to carry any weight;

There is eliminated the removal of “crust” with the use of blowtorches, pneumatic equipment and/or impacts, preserving the integrity of the equipment and of the internal refractory coatings to protect the equipment from involuntary backflow of incandescent liquid;

Better service quality for the employed involved in the operation;

Facility of application. The compound can be pulverized, painted, sprinkled, applied by immersion, by brushing, with clothes and even sprayed;

Reduction of the time of exposure of the applicator to the heat source;

Increase of the useful life of the protected equipment;

Increase in productivity, since the equipment is released back to operation faster;

Increased profitability, excellent cost-benefit ratio;

Reduction of the risk of accidents caused by removal of the crust.

### DETAILED DESCRIPTION

Sodium tripolyphosphate should be separately dissolved in water until homogenized; after poured in the production tank with the engine on. The same process should be used with the citric acid. After the above mixtures are homogenized there the sodium hydroxide should be added directly to the mixture.

Subsequently there is added sodium ricinoleate directly into the mixture and the same should be very thoroughly homogenized to be fully dissolved. Once the mixture is completely homogeneous sodium silicate is added. After it is homogenized, benzalkonium chloride should be added, followed by sulfonic acid, which should be very thoroughly mixed.

The gum should be separately well dissolved in water and, after it is fully hydrated, the mixture should be added to the production tank that continues in beating process.

When all the ingredients are totally mixed, the remaining silicone and water plus isothiazolinone are added, in this order; and mixed for two hours; the mixture should be left to rest for up to four hours, and subsequently the pH should be adjusted to 7.20±0.5. If there is no more foam left bottling can be undertaken.

The instant invention presents a chemical compound comprising various substances, according to the qualitative and quantitative formulation below:

| SUBSTANCE | MINIMUM/1.0 kg | MAXIMUM/1.0 kg |
|---|---|---|
| Sodium Tripolyphosphate | 0.90 kg | 54.04 kg |
| Citric acid | 1.00 kg | 60.80 kg |
| Sodium Hydroxide | 1.05 kg | 63.08 kg |
| Sodium Ricinoleate | 3.60 kg | 216.60 kg |
| Sodium Silicate | 0.45 kg | 27.06 kg |
| Benzalkonium Chloride | 0.18 kg | 1.80 kg |
| Gum | 0.18 kg | 11.05 kg |
| Silicone Oil | 0.20 kg | 12.01 kg |
| Water | 992.34 kg | 293.20 kg |
| Isothiazolinone | 0.10 kg | 1.60 kg |
| Sulfonic Acid | 4.30 kg | 258.30 kg |
| Sodium Hydroxide | qs | qs |

qs = quod satis [sufficient quantity] to standardize (complete) the volume of the formula.

Other applications cover various technological fields, among which we point out some as examples and not in a limitative sense:

### INDUSTRIAL FIELD

Apply directly on the surfaces whereon it is desired to avoid the adherence of welding splash;

Apply on robot welding clamps;

Apply on manual welding clamps in general;

Apply on floors in general to prevent the adherence of welding splash and leaks of metal alloys, aluminum alloys and other types of alloys;

Application in boiler making in order to protect the equipment from welding residues in general;

### Steel Mills:

Application in the gate valve system;

Pot rims;

Outer walls;

Pot tails or handle;

Inspection box;

Outflow valves;

Pot vault.

### Converters:

Converter rims;

Converter vaults;

Spillway;

Outer wall;

Shafts and bearings;

Oxygen lances;

Sub-lances;

Spillway gutters;

Converter hood;

### Torpedo Carts:

Torpedo cart edges;

Outer wall;

Upper refractory materials.

### Slag Pots:

Prevent adhesion of crust both internally and externally;

### Liquid Steel Distributors in General:

Valves requiring protection or that contact molten material.

### In Exploration Probes:

### Refractory Materials in General:

It can be pulverized on refractory materials of the most various segments to increase their resistance and durability in industrial processes, improving their effectiveness and profitability.

It can be used in the mass composition of the refractory materials to increase the resistance thereof to friction by the liquefied materials produced inside the equipment coated with such refractory materials.

### Kitchens:

The product can be applied externally on kitchenware that accumulates carbon on the outer parts thereof, such as pots, molds, roasting pans, oven edges, fryers, and stove hoods, caused by adherence and burning of fat on the utensils or by the faulty regulation of the flames and/or by the LPG quality. It also prevents adherence of black smoke produced in wood stoves to the respective utensils.

Since the product does not contain natural and aliphatic solvents it does not cause irritations and intoxication to the users. The amount to be used depends on the surface size.

1-9. (canceled)

10. A process for producing an anti-adherent semi-paste compound for liquid steel on solid metal, the process comprising homogenizing a plurality of substances together with water, the substances each ranging in concentration between a minimum value and a maximum value and including sodium tripolyphosphate, citric acid, sodium hydroxide, sodium ricinoleate, sodium silicate, benzalkonium chloride, gum, silicone oil, water, isothiazolinone, sulfonic acid, and sodium hydroxide, wherein a mixture obtained from homogenizing the substances has a pH of 7.20±0.5.

11. The process of claim 10, wherein homogenizing the plurality of substances includes:
separately dissolving the sodium tripolyphosphate in water until the sodium tripolyphosphate and water become homogeneous;
adding the homogenized sodium tripolyphosphate and water mixture to a production tank coupled to an engine powered on;
separately dissolving the citric acid in water until the citric acid and water become homogeneous;
adding the homogenized citric acid and water mixture to the production tank;
adding the sodium hydroxide to the production tank;
dissolving the sodium ricinoleate into the mixture in the production tank until the sodium ricinoleate and the mixture become homogeneous;
adding the sodium silicate to the mixture;
adding the benzalkonium chloride to the mixture;
adding the sulfonic acid to the mixture;
separately dissolving the gum in water and adding the gum and water mixture to the mixture in the production tank when the gum has become fully hydrated in the water;
adding the silicone and water plus isothiazolinone to the mixture in the production tank;
mixing the mixture in the production tank for two hours;
allowing the mixture in the production tank to rest for up to four hours; and
adjusting the pH of the mixture in the production tank to 7.20±0.5.

12. An anti-adherent semi-paste compound for liquid steel on solid metal, the compound comprising a plurality of substances each ranging in concentration between an approximately minimum value and an approximate maximum value, the substances including:

| | APPROXIMATE | | APPROXIMATE | |
|---|---|---|---|---|
| SUBSTANCE | MINIMUM/1.0 kg | | MAXIMUM/1.0 kg | |
| Sodium Tripolyphosphate | 0.90 | kg | 54.04 | kg |
| Citric acid | 1.00 | kg | 60.80 | kg |
| Sodium Hydroxide | 1.05 | kg | 63.08 | kg |
| Sodium Ricinoleate | 3.60 | kg | 216.60 | kg |
| Sodium Silicate | 0.45 | kg | 27.06 | kg |
| Benzalkonium Chloride | 0.18 | kg | 1.80 | kg |
| Gum | 0.18 | kg | 11.05 | kg |
| Silicone Oil | 0.20 | kg | 12.01 | kg |
| Water | 992.34 | kg | 293.20 | kg |
| Isothiazolinone | 0.10 | kg | 1.60 | kg |
| Sulfonic Acid | 4.30 | kg | 258.30 | kg |
| | | |
|---|---|---|
| Sodium Hydroxide | quod satis | quod satis |

13. The anti-adherent semi-paste compound of claim 12, wherein the compound prevents the adherence of welding splash.

14. The anti-adherent semi-paste compound of claim 12, wherein the compound increases a level of resistance and a level of durability of one or more refractory materials when pulverized on the one or more refractory materials.

15. The anti-adherent semi-paste compound of claim 13, wherein the compound increases a level of resistance and a level of durability of one or more refractory materials when pulverized on the one or more refractory materials.

16. The anti-adherent semi-paste compound of claim 12, wherein the compound increases a level of resistance to friction of one or more liquefied materials produced inside equipment coated with one or more refractory materials when the compound is used in the mass composition of the one or more refractory materials.

17. The anti-adherent semi-paste compound of claim 13, wherein the compound increases a level of resistance to friction of one or more liquefied materials produced inside equipment coated with one or more refractory materials when the compound is used in the mass composition of the one or more refractory materials.

18. The anti-adherent semi-paste compound of claim 14, wherein the compound increases a level of resistance to friction of one or more liquefied materials produced inside equipment coated with one or more refractory materials when the compound is used in the mass composition of the one or more refractory materials.

19. The anti-adherent semi-paste compound of claim 12, wherein the compound prevents adherence of a black smoke to one or more utensils when the compound is applied to the one or more utensils before coming into contact with the black smoke.

20. The anti-adherent semi-paste compound of claim 13, wherein the compound prevents adherence of a black smoke to one or more utensils when the compound is applied to the one or more utensils before coming into contact with the black smoke.

21. The anti-adherent semi-paste compound of claim 14, wherein the compound prevents adherence of a black smoke to one or more utensils when the compound is applied to the one or more utensils before coming into contact with the black smoke.

22. The anti-adherent semi-paste compound of claim 16, wherein the compound prevents adherence of a black smoke to one or more utensils when the compound is applied to the one or more utensils before coming into contact with the black smoke.

23. The anti-adherent semi-paste compound of claim 12, wherein the compound does not include natural and aliphatic solvents.

24. The anti-adherent semi-paste compound of claim 13, wherein the compound does not include natural and aliphatic solvents.

25. The anti-adherent semi-paste compound of claim 14, wherein the compound does not include natural and aliphatic solvents.

26. The anti-adherent semi-paste compound of claim 16, wherein the compound does not include natural and aliphatic solvents.

27. The anti-adherent semi-paste compound of claim 19, wherein the compound does not include natural and aliphatic solvents.

28. The anti-adherent semi-paste compound of claim 12, wherein an amount of the compound to be used in an application is dependent on the size of a surface to which the compound will be applied.

29. The anti-adherent semi-paste compound of claim 13, wherein an amount of the compound to be used in an application is dependent on the size of a surface to which the compound will be applied.
